(19) United States
(12) Patent Application Publication
(10) Pub. No.: US 2004/0196559 A1
(43) Pub. Date: Oct. 7, 2004

(54) Apparatus for applying laser radiation to an object, processing apparatus for processing an object, and printing apparatus for printing image information

(76) Inventor: Vitalij Lissotschenko, Frondenberg (DE)

Correspondence Address: Stewart L. Gitler, Esq., HOFFMAN, WASSON & GITLER, PC, 2461 South Clark Street, Suite 522, Arlington, VA, 22202, US

(21) Appl. No.: 10/785,482

(22) Filed: Feb. 25, 2004

(30) Foreign Application Priority Data
Feb. 28, 2003 (DE) 103 08 708.7

(51) Int. Cl. G02B 27/10

(52) U.S. Cl. 359/619

(57) ABSTRACT

Apparatus for applying laser radiation to an object, including a laser light source for generating laser radiation, a two-dimensional array of influencing elements that can deflect and/or pass the laser radiation issuing from the laser light source in such a way that laser radiation is applied to prescribable locations on the object, and a two-dimensional array of lens elements that can focus the laser radiation or portions of the laser radiation onto the surface—to which radiation is to be applied—of the object, the array of lens elements being arranged between the laser light source and the array of influencing elements. The present invention also relates to a processing apparatus and to a printing apparatus having an apparatus according to the invention.

### BACKGROUND OF THE INVENTION

The present invention relates to an apparatus for applying laser radiation to an object, including a laser light source for generating laser radiation, a two-dimensional array of influencing elements that can deflect and/or pass the laser radiation issuing from the laser light source in such a way that laser radiation is applied to prescribable locations on the object, and a two-dimensional array of lens elements that can focus the laser radiation or portions of the laser radiation onto the surface—to which radiation is to be applied—of the object. The present invention also relates to a processing apparatus for processing an object and having such an apparatus, and to a printing apparatus for printing image information and having such an apparatus.

Apparatuses of the type mentioned at the beginning are disclosed, for example, in international patent application WO 97/34171. Such apparatuses for applying laser radiation to an object can be used, for example, as printing apparatuses or else as processing apparatuses. Various possible applications come into consideration as processing apparatus, for example laser welding, laser drilling or laser cutting, or else lithographic applications for chip fabrication. In the case of the abovenamed international patent application, the two-dimensional array of influencing elements can consist in the simplest case of a perforated mask. As an alternative thereto, the array can also consist of small mirror elements. The two-dimensional array of lens elements serves in each case to project and/or to focus the laser radiation issuing from the individual influencing elements onto the surface to be treated.

It turns out to be disadvantageous in this regard that the filling factor of a perforated mask or a mirror array is mostly noticeably smaller than 100%, and so only a comparatively small fraction, for example 50%, of the laser radiation impinging on the array of influencing elements is passed or reflected, with the result that it is also only this comparatively small fraction of the laser radiation that can be used for the processing.

The problem on which the present invention is based is the provision of an apparatus of the type mentioned at the beginning that is more effective.

### SUMMARY OF THE INVENTION

It is provided that the array of lens elements is arranged between the laser light source and the array of influencing elements. The effectiveness of the apparatus according to the invention can be substantially enhanced by means of such a measure. For example, the lens elements can be embodied as convex lenses such that the laser radiation is more or less strongly convergent after penetrating the array of lens elements. It is possible as a result of this for the laser radiation to impinge more effectively on the influencing elements.

In particular, the array of influencing elements can correspond to the array of lens elements, in particular to the effect that each influencing element is essentially assigned one lens element. It is preferably possible in this case to provide that the focal lengths of the lens elements are selected in such a way that the partial beams of the laser radiation that have penetrated the individual lens elements impinge substantially on the influencing elements and not on an interspace, possibly present between the influencing elements, of the array of influencing elements. Consequently, in the ideal case none of the laser radiation that has penetrated the array of lens elements is lost. The sole losses occur, for example, from construction-induced losses of the individual influencing elements.

It is provided that the lens elements are designed as mutually crossed cylindrical lens elements or elements similar to cylindrical lenses. Mutually crossed cylindrical lens elements in each case form lens elements that can be embodied, for example, as convex lens elements or as positive lens elements. By contrast with spherical lens elements, lens elements made from crossed cylindrical lenses firstly have a shape factor of almost 100%. In arrays of spherical lenses there are always spandrel-like areas between the individual lenses that cannot be used for the light throughput. Secondly, the focal points formed by crossed cylindrical lenses are generally square, and this is of substantial advantage for applications in the printing industry, for example, because square image pixels are better suited here than circular image pixels.

It is possible according to the invention that a homogenization unit for homogenizing the laser radiation is arranged between the laser light source and the array of lens elements. Such homogenization units are suitable in particular whenever the laser radiation is very inhomogeneous, which is the case, for example, with excimer lasers or with semiconductor lasers.

In accordance with a preferred embodiment of the present invention, the array of influencing elements is designed as a modulator array with modulator elements. The modulators can be, for example, electrooptic or electroacoustic modulators. The information required for processing or for printing can be modulated onto the laser radiation by means of the for example electrooptic modulator elements.

In accordance with an alternative embodiment of the present invention, the array of influencing elements is designed as a mirror array with mirror elements. The mirror array can be embodied, in particular, as a MEMS mirror array. With such MEMS mirror arrays, the individual mirror elements can be tilted or swiveled independently of one another such that the laser radiation can be modulated in accordance with the processing stipulations or printing information by appropriate tilting or swiveling of the individual mirror elements.

It can be provided, in particular, that a perforated mask is arranged between the mirror array and the object. For example, partial beams that are not to impinge on the object can be directed by one of the mirror elements onto the interspaces between the perforations of the perforated mask such that the perforated mask absorbs these undesired partial beams.

It is provided, in accordance with claim 27, that the array of influencing elements can be controlled in such a way that partial beams of the laser radiation impinge in a fashion offset from one another in time on the prescribable locations—to which radiation is to be applied—of the object, or on locations directly adjacent thereto. It is possible in this case, for example, that the desired laser power can be introduced into a prescribable area on the surface—to which radiation is to be applied—by spatial and/or temporal summation. By contrast with the prior art, an image pixel is thus not attained, for example, in the course of a printing application or an exposure during a processing application with the aid of a single continuous partial beam at a specific location, but by two or more partial beams that impinge one after another and, in some circumstances, also in a fashion slightly offset from one another, on the area—to be processed or to which radiation is to be applied—of the surface of the object. It is possible thereby in the case of sensitive media that are to be processed, for example, for the laser power required for the desired change to the surface of the object to be stretched over a somewhat longer period of time or to be distributed over a larger area such that the object or the surface of the object does not suffer any undesired damage. As an alternative or in addition thereto, the individual partial beams could also be finely focused, for example in order to form a square image pixel of a specific size, in such a way that they do not cover the entire surface of the image pixel in each case, but only individual sections. The required laser intensity can thus, finally, be applied to the entire surface of the image pixel to be formed, for example, by means of the spatial and, for example, also temporal summation of a whole range of partial beams.

It is possible in accordance with a preferred embodiment of the present invention that the apparatus comprises two mirror arrays with mirror elements that are arranged in such a way that it is possible to generate partial beams of the laser radiation that impinge asymmetrically in relation to the normal to the surface—to which radiation is to be applied—of the object. For this purpose, the individual mirror elements of the different mirror arrays, which reflect one of the partial beams jointly or one after another, can be tilted slightly to their normal position such that the corresponding partial beam impinges at a small angle to the normal to the surface—to which radiation is to be applied—of the object, or at an angle to an additional lens means or lens array that is arranged in front of the surface of the object, if appropriate. It is possible to use partial beams impinging asymmetrically in such a way in relation to the normal to the surface—to which radiation is to be applied—of the object in order, for example, to cut into the object holes that do not have conical inner contours, but ones that are comparatively cylindrical.

The possibility also exists that the apparatus comprises scanning means that permit the object to be scanned with reference to the apparatus, or permit the apparatus to be scanned with reference to the object. Such scanning means provide the apparatus with the possibility of applying laser radiation to large areas of a surface of the object in a targeted fashion.

Furthermore, the apparatus can comprise scanning means that permit the array of lens elements to be scanned with reference to the object and/or to the array of influencing elements. It can further be provided that, in a plane perpendicular to the propagation direction, the array of lens elements is tilted slightly to a scanning direction in which it can be displaced, this scanning direction lying in a plane perpendicular to the propagation direction. Corresponding partial beams can be applied in a sequential fashion to points lying very close to one another on the surface by scanning with the aid of a lens array that is slightly tilted in a plane perpendicular to the propagation direction and is, for example, designed as a cylindrical lens array. In this way, it is possible for the apparatus according to the invention to apply laser radiation with a higher resolution to the object to which radiation is to be applied.

### BRIEF DESCRIPTION OF THE DRAWINGS

Further features and advantages of the present invention will become clear from the following description of preferred exemplary embodiments with reference to the attached figures, in which:

FIG. 1a shows a schematic side view of a first embodiment of an apparatus according to the invention;

FIG. 1b shows a view of an array of lens elements in accordance with arrow Ib in FIG. 1a;

FIG. 2a shows a schematic side view of a further embodiment of an apparatus according to the invention;

FIG. 2b shows a view of an array of lens elements in accordance with arrow IIb in FIG. 2a;

FIG. 3a shows a schematic side view of a further embodiment of an apparatus according to the invention;

FIG. 3b shows a view of an array of lens elements in accordance with arrow IIIb in FIG. 3a;

FIG. 3c shows a view of an array of lens elements in accordance with arrow IIIc in FIG. 3a;

FIG. 4 shows a section in accordance with IV in FIG. 3a through a detail of an object processed with the aid of an apparatus according to the invention; and

FIG. 5 shows a section in accordance with V in FIG. 3a through a further detail of an object processed with the aid of the apparatus according to the invention.

A Cartesian coordinate system is depicted in some of the figures for the purpose of illustration.

### DETAILED DESCRIPTION OF THE INVENTION

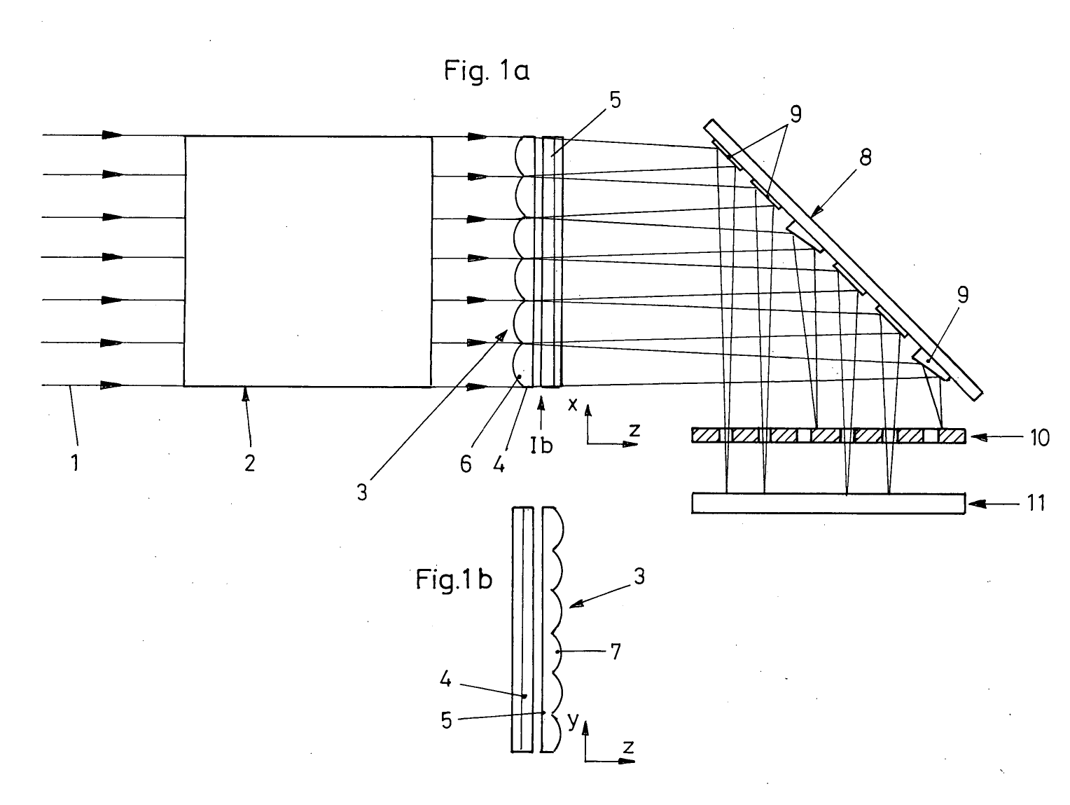

The embodiment of an apparatus according to the invention to be seen in FIG. 1a and FIG. 1b comprises a laser light source for generating laser radiation 1. Any desired types of laser apparatuses such as, for example, semiconductor lasers or gas lasers, in particular excimer lasers, can be used as laser light source. The laser radiation 1 generated by the laser light source penetrates a homogenization unit 2. This homogenization unit homogenizes the laser radiation 1. Homogenization is particularly expedient in the case of semiconductor lasers or excimer lasers. This homogenization unit can consist, for example, of two pairs of cylindrical lens arrays, each pair having two cylindrical lens arrays, the cylindrical lenses of which are mutually crossed. The two pairs can be spaced apart from one another, it being possible to exert influence on the homogenization by means of the mutual spacing of the pairs. Such homogenization units 2 are known from the prior art. In particular, a homogenization unit is known from WO 98/10317. The homogenization unit 2 depicted in FIG. 1a can further also comprise lens means for the collimation of the laser radiation such that the light emerging from the homogenization unit 2 is collimated.

The light emerging from the homogenization unit 2 strikes an array 3 of lens elements 6, 7. These lens elements 6, 7 are distributed over two substrates 4, 5 in the exemplary embodiment depicted in FIG. 1a and FIG. 1b. Cylindrical lens elements 6 with cylinder axes in the Y-direction are formed on the entrance surface of the first substrate 4 in the propagation direction Z, whereas cylindrical lens elements 7 with cylinder axes in the X-direction are formed on the exit surface of the second substrate 5 in the propagation direction Z. These mutually crossed lens elements 6, 7 thus form lens elements that can focus the laser radiation both in the X-direction and in the Y-direction. As an alternative to this, the lens elements 6, 7 can also be formed on the entrance surface or exit surface of a single substrate.

Following the array 3, the convergent laser radiation leaving the array 3 strikes a mirror array 8 with individual mirror elements 9. The mirror array 8 is designed in this case as a MEMS mirror array. MEMS denotes “MicroElectroMechanical System”. The mirror elements 9 of the two-dimensional mirror array 8 can be moved or tilted individually by a certain angle such that the convergent laser beams impinging on the mirror elements 9 can be partially deflected. For example, in FIG. 1a the third and sixth mirror elements 9 from the left are slightly tilted such that the laser beams reflected by these mirror elements have a different propagation direction than the laser beams reflected by the other mirror elements.

In the embodiment of an apparatus according to the invention depicted in FIG. 1a and FIG. 1b, the mirror array 8 is followed by a two-dimensional perforated mask 10 that, for example, passes the laser beams not issuing from tilted mirror elements 9. This is illustrated in FIG. 1a by virtue of the fact that the laser beams reflected by the tilted mirror elements 9 do not penetrate the holes of the perforated mask 10, but impinge on their lateral boundaries. Such a perforated mask 10 can, in particular, be water cooled in order to dissipate the power of the laser beams not passing through the holes.

In FIG. 1a, the laser radiation penetrating the perforated mask 10 strikes an object 11 to which radiation is to be applied. The object 11 can be a workpiece to be processed, for example. However, it is also possible for the object 11 to be part of a printing apparatus, for example a printing roller to be irradiated or the like, such that printing information is transferred with the aid of the laser radiation onto a thermally sensitive material.

The information for processing a workpiece or for generating image pixels of a printout can be modulated onto the laser radiation via the mirror array 8. The mirror array 8 thus serves as a two-dimensional array of influencing elements.

The array 3 of lens elements 6, 7 that are cylindrical or resemble cylinders has in essence a filling factor of 100%. This means that essentially or almost 100% of the laser radiation emerging from the homogenization unit 2 and entering the array 3 emerges from the array 3. This distinguishes arrays composed of crossed cylindrical lenses from arrays composed of spherical lens elements, which have a substantially lower filling factor. The mirror array 8 has a filling factor of approximately 50%. This means that the reflecting surfaces of the mirror elements 9 constitute approximately 50% of the area of the mirror array 8 inclined toward the laser radiation. It is clearly to be seen from FIG. 1a that the array 3 causes the laser radiation to converge in such a way that the partial beams penetrating the individual lens elements 6, 7 impinge in each case precisely on one mirror element 9 and not on the interspace that is formed between the mirror elements 9 and is not of any use for reflection. Consequently, in essence the laser radiation loses no intensity through the reflection of the laser radiation at the mirror array 8. This can be achieved, in particular, by virtue of the fact that each partial beam that has penetrated a lens element 6, 7 impinges on precisely one mirror element 9.

It is likewise to be seen from FIG. 1a that the focal lengths of the lens elements 6, 9 are selected in such a way that the laser radiation penetrating the array 3 is focused in essence on the surface of the object 11. In particular, the holes of the perforated mask 10 are also selected in such a way that the individual partial beams pass through precisely one of these holes in each case. For example, the perforated mask can have a filling factor of 30%. This means that 30% of the perforated mask 10 is formed by the holes, whereas the other 70% is formed by the interspaces existing between the holes. The apparatus depicted in FIG. 1a thus maximizes the intensity of the laser radiation 1 focused onto the object.

Furthermore, mutually crossed cylindrical lenses yield, in particular, square foci, the result being clear advantages by contrast with the round foci of spherical lenses, in particular for applications in printing apparatuses. In this case, the result is then not round image pictures, but square ones.

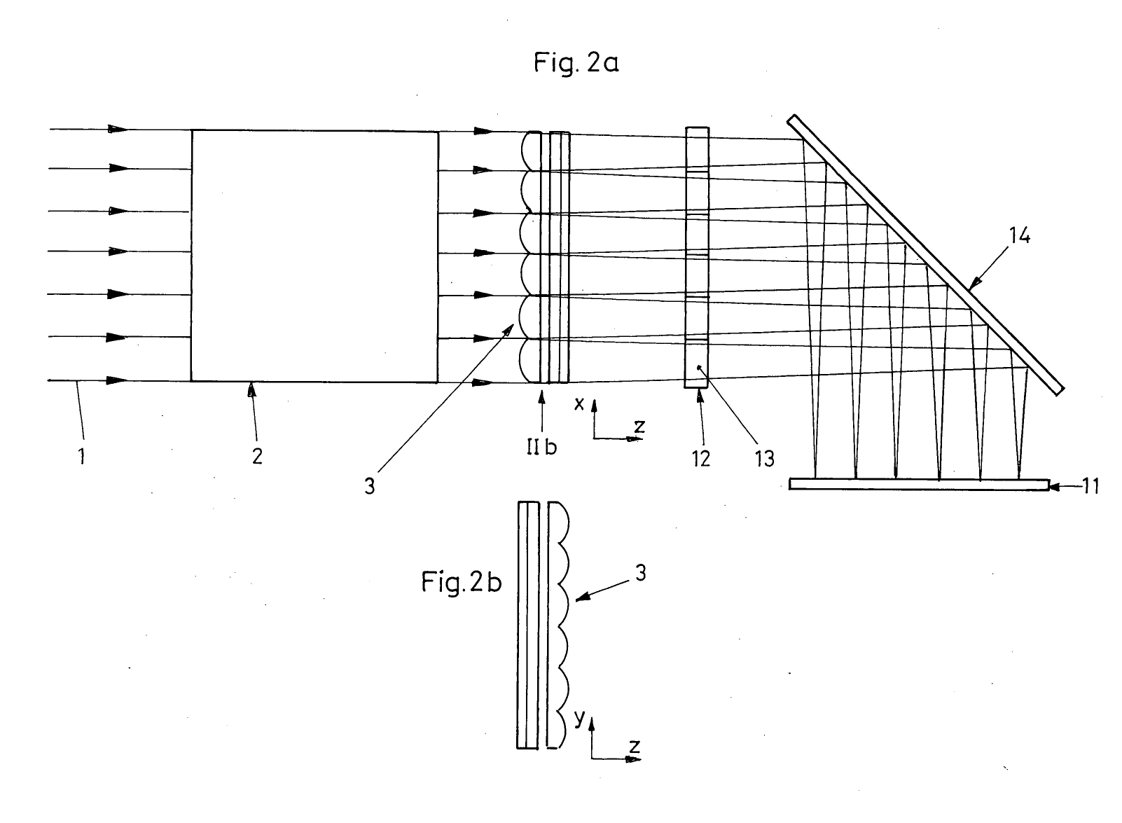

The second embodiment, to be seen from FIG. 2a and FIG. 2b, of an apparatus according to the invention substantially resembles the embodiment in accordance with FIG. 1a and FIG. 1b. In particular, identical parts in FIG. 2a and FIG. 2b are provided with identical reference symbols to those in FIG. 1a and FIG. 1b.

Instead of a mirror array 8 and a perforated mask 10, the embodiment in accordance with FIG. 2a and FIG. 2b provides a modulator array 12 with modulator elements 13. The modulators can be electrooptic modulators, for example. The modulator array 12 is arranged between the array 3 of lens elements 6, 7 and a mirror 14 that is aligned at an angle of 45° to the propagation direction of the laser radiation. The laser radiation is reflected onto the object 11 by the mirror. The mirror 14 is optional. Alternatively, it would also be possible to arrange the object 11 in an XY plane and therefore to the right of the modulator array 12 in the Z-direction.

The filling factor of the array 3 of lens elements 6, 7 is likewise approximately 100%. The filling factor of the modulator array 12 is approximately 80%. The filling factor of the modulator array 12 has therefore to be understood as the area useful for transmitting the laser radiation. Again, the focal lengths of the lens elements 6, 7 are selected such that the laser radiation is focused onto the surface—to which radiation is to be applied—of the object 11.

Information to be applied to the object 11, such as printing information or processing information, for example, can therefore be modulated onto the laser radiation by the modulator array 12 in the case of the embodiment in accordance with FIG. 2a and FIG. 2b.

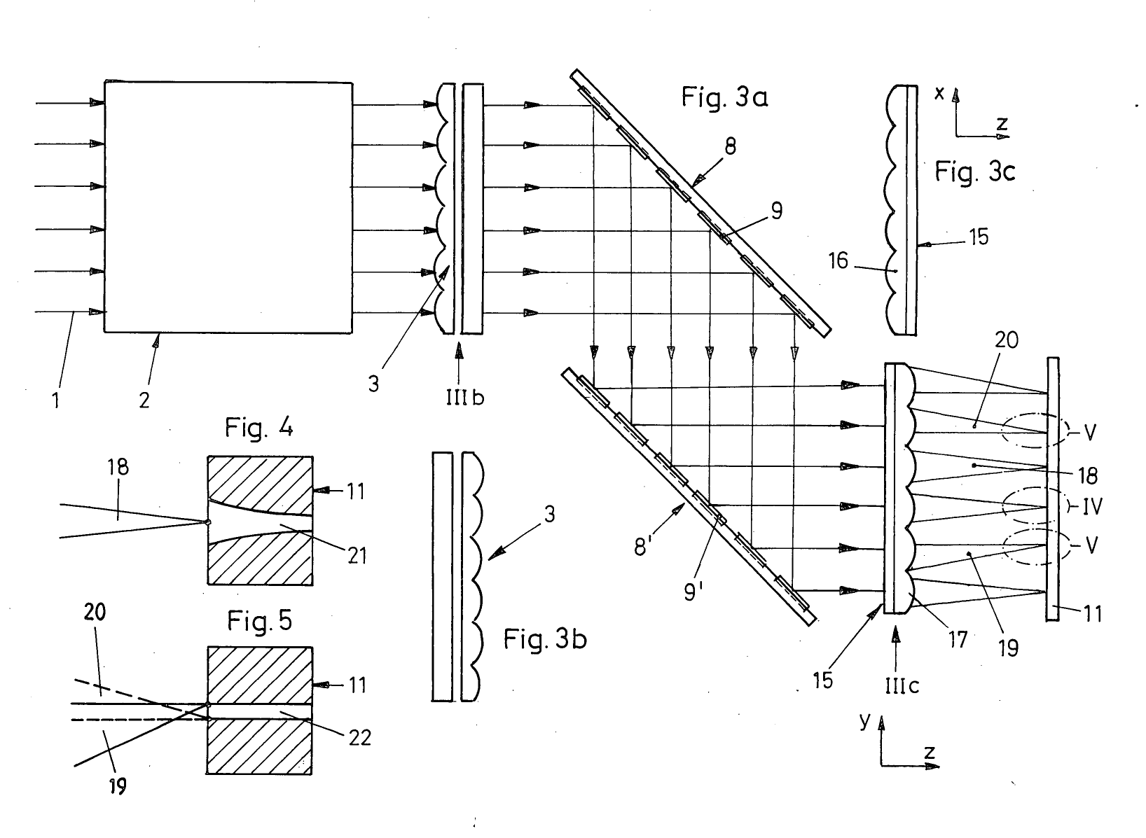

In the case of the embodiment in accordance with FIG. 3a and FIG. 3b, identical parts are once again provided with identical reference symbols to those in FIGS. 1a, 1b, 2a and 2b.

The embodiment in accordance with FIG. 3a, FIG. 3b and FIG. 3c likewise has a mirror array 8, which is arranged following the array 3 in the beam path of the laser radiation 1. This mirror array 8 reflects the laser radiation in the negative X-direction, that is to say downward in FIG. 3a, by an angle of 90°. The laser radiation reflected in such a way strikes a further mirror array 8′ that is, for example, of exactly the same design as the mirror array 8. The second mirror array 8′ is arranged rotated by 180° parallel to the first mirror array 8 such that the laser radiation impinging on the second mirror array 8′ is likewise reflected in the positive Z-direction at an angle of 90°.

The laser radiation reflected by these two mirror arrays 8, 8′ can either impinge directly on the object 11, or else previously be additionally focused by a further lens array, as well. A further array 15 is depicted by way of example in FIG. 3a and in FIG. 3c. This array 15 can be embodied on a substrate, for example, and have on the entrance surface cylindrical lenses 16 whose cylinder axes are aligned in the X-direction, and which have on the exit side cylindrical lenses 17 whose cylinder axes are aligned in the Y-direction. The partial beams 18, 19, 20 issuing from the array 15 can be formed differently because of the mirror array 8, 8′; in particular, the partial beam 18 is symmetrical in relation to the normal to the surface—to which radiation is to be applied—of the object 11, whereas, for example, the partial beams 19, 20 are in each case asymmetric in relation to the normal to the surface—to which radiation is to be applied—of the object 11.

The configuration of the partial beams 18, 19, 20 emerges with particularly clarity, once again, in FIG. 4 and FIG. 5. FIG. 4 shows the effect of a partial beam 18 formed symmetrically in relation to the normal to the surface—to which radiation is to be applied—of the object 11. Such a partial beam 18 will introduce a conical hole 21 into the object 11 in the case, for example, when it is provided for processing the surface, in particular for drilling holes, the diameter of the hole 21 decreasing with increasing depth of the hole.

By contrast, it is possible to introduce an essentially cylindrical hole 22 into the object 11, for example by sequentially applying to the object 11 partial beams 19, 20 that are aligned asymmetrically in relation to the normal to the surface—to which radiation is to be applied—of the object 11.

It is possible according to the invention for partial beams 19, 20 arranged asymmetrically in opposition in such a way to be caused to impinge sequentially, in particular in a fashion alternating with one another multiply, on the surface of the object 11 that is to be processed. The asymmetric partial beams 19, 20 are produced by virtue of the fact that because of slight tilting of the mirror elements 9, 9′ they can impinge, at an angle deviating slightly from the normal, on the surface—to which radiation is to be applied—of the object 11, or on a lens array optionally placed upstream. This process is indicated only schematically in FIG. 3a.

The apparatus according to the invention can additionally be provided with an adaptive distance control that can vary, in particular shorten, the distance of the object 11 from the array 3 or the array 15 with advancing penetration into the material of the object 11 during cutting of a hole 21, 22 in the object 11, such that the focal points are always exactly in the processing area.

In the embodiment of an apparatus according to the invention that is depicted in FIG. 3a and FIG. 3b, there is the possibility, in turn, that the array 3 focuses the laser radiation 1 in such a way that the beam cross section of the individual partial beams is designed on impinging on the mirror arrays 8, 8′ in accordance with the respective filling factor of, for example, 50% of the mirror arrays 8, 8′, such that no light intensity, or only an insubstantial amount, is lost upon reflection at the mirror arrays 8, 8′.

In particular, in the case of all the embodiments previously mentioned, it is possible for the surface—to which radiation is to be applied—of the object 11 to experience this application not continuously, but in a pulsed fashion. One example was illustrated in conjunction with FIG. 3a and FIG. 5, in that differently asymmetric partial beams 19, 20 impinge sequentially on an object 11 in order to form a cylindrical hole 22. It is to be noted here also that the focal points of the partial beams 19, 20 impinge at different locations on the surface—to which radiation is to be applied—of the object 11. It is therefore also entirely possible to cause the partial beams of the laser radiation 1 that impinge sequentially or simultaneously on specific areas of the surface—to which radiation is to be applied—of the object 11 to impinge at mutually differing locations. The entire light intensity impinging in a specific area of the surface—to which radiation is to be applied—of the object 11 therefore results from a spatial and temporal summation or from a corresponding integral over an area and time.

Such a summation over spatially and temporally differing partial beams or pulses of partial beams can be expedient both in the case of a laser processing apparatus with an apparatus according to the invention, and in the case of a printing apparatus having an apparatus according to the invention. The spatial and temporal control of the individual partial beams can be performed either by the mirror array 8, by the mirror arrays 8, 8′ or by the modulator array 12.

The apparatus according to the invention can further comprise scanning means that permit the object 11 to be scanned with reference to the apparatus, or permit the apparatus to be scanned with reference to the object 11. Furthermore, the same or other scanning means can be provided that permit the array 3 of lens elements 6, 7 to be moved with reference to the object 11, or with reference to the mirror array 8, 8′ or to the modulator array 12. In particular, the array 3 of lens elements 6, 7 can be slightly tilted in a plane X,Y perpendicular to the propagation direction Z, the scanning direction in which the array 3 can be displaced likewise lying in the XY plane, in particular corresponding to the X-direction, for example. By means of the slight tilting, for example in the case of stepwise displacement of the array 3 by in each case a distance between individual lens elements 6, 7, the lens elements 6, 7, contributing after the stepwise displacement to the focusing of the laser radiation 1 onto the object 11, can be displaced somewhat in the Y-direction with reference to the positions that they had assumed before this displacement step. It is possible in this way for appropriately focused partial beams to be applied to points spaced apart very little from one another on the surface—to which radiation is to be applied—of the object 11. The result is a higher resolution of the processing apparatus.

What is claimed is:

1. An apparatus for applying laser radiation to an object, comprising:
a laser light source for generating laser radiation;
a two-dimensional array of influencing elements that can deflect and/or pass the laser radiation issuing from the laser light source in such a way that laser radiation is applied to prescribable locations on the object; and
a two-dimensional array of lens elements that can focus the laser radiation or portions of the laser radiation onto the surface—to which radiation is to be applied—of the object;
wherein the array of lens elements is arranged between the laser light source and the array of influencing elements.

2. The apparatus as claimed in claim 1, wherein the array of influencing elements corresponds to the array of lens elements, in particular to the effect that each influencing element is essentially assigned one lens element.

3. The apparatus as claimed in claim 1, wherein the focal lengths of the lens elements are selected in such a way that the partial beams of the laser radiation that have penetrated the individual lens elements impinge substantially on the influencing elements and not on an interspace, possibly present between the influencing elements, of the array of influencing elements.

4. The apparatus as claimed in claim 1, wherein the lens elements are designed as mutually crossed cylindrical lens elements or elements similar to cylindrical lenses.

5. The apparatus as claimed in claims 1, wherein a homogenization unit for homogenizing the laser radiation is arranged between the laser light source and the array of lens elements.

6. The apparatus as claimed in claim 1, wherein the array of influencing elements is designed as a modulator array with modulator elements.

7. The apparatus as claimed in claim 6, wherein the modulator elements are designed as electrooptic modulators or acoustooptic modulators.

8. The apparatus as claimed in claim 1, wherein the array of influencing elements is designed as a mirror array with mirror elements.

9. The apparatus as claimed in claim 8, wherein the mirror array is embodied as a MEMS mirror array.

10. The apparatus as claimed in claim 8, wherein a perforated mask is arranged between the mirror array and the object.

11. The apparatus as claimed in claim 1, wherein the array of influencing elements can be controlled in such a way that partial beams of the laser radiation impinge in a fashion offset from one another in time on the prescribable locations—to which radiation is to be applied—of the object, or on locations directly adjacent thereto.

12. The apparatus as claimed in claim 1, wherein the apparatus comprises scanning means that permit the object to be scanned with reference to the apparatus, or permit the apparatus to be scanned with reference to the object.

13. The apparatus as claimed in claim 1, wherein the apparatus comprises scanning means that permit the array of lens elements to be scanned with reference to the object and/or to the array of influencing elements.

14. The apparatus as claimed in claim 13, wherein, in a plane (X, Y) perpendicular to the propagation direction (Z), the array of lens elements is tilted slightly to a scanning direction (X) in which it can be displaced, this scanning direction (X) lying in a plane (X, Y) perpendicular to the propagation direction (Z).

15. An apparatus for applying laser radiation to an object, comprising:
a laser light source for generating laser radiation;
a two-dimensional array of influencing elements that can deflect and/or pass the laser radiation issuing from the laser light source in such a way that laser radiation is applied to prescribable locations on the object; and
a two-dimensional array of lens elements that can focus the laser radiation or portions of the laser radiation onto the surface—to which radiation is to be applied—of the object;
wherein the lens elements are designed as mutually crossed cylindrical lens elements or elements similar to cylindrical lenses.

16. The apparatus as claimed in claim 15, wherein a homogenization unit for homogenizing the laser radiation is arranged between the laser light source and the array of lens elements.

17. The apparatus as claimed in claim 15, wherein the array of influencing elements is designed as a modulator array with modulator elements.

18. The apparatus as claimed in claim 17, wherein the modulator elements are designed as electrooptic modulators or acoustooptic modulators.

19. The apparatus as claimed in claim 15, wherein the array of influencing elements is designed as a mirror array with mirror elements.

20. The apparatus as claimed in claim 19, wherein the mirror array is embodied as a MEMS mirror array.

21. The apparatus as claimed in claim 19, wherein a perforated mask is arranged between the mirror array and the object.

22. The apparatus as claimed in claim 15, wherein the array of influencing elements can be controlled in such a way that partial beams of the laser radiation impinge in a fashion offset from one another in time on the prescribable locations—to which radiation is to be applied—of the object, or on locations directly adjacent thereto.

23. The apparatus as claimed in claim 19, wherein the apparatus comprises two mirror arrays with mirror elements that are arranged in such a way that it is possible to generate partial beams of the laser radiation that impinge asymmetrically in relation to the normal to the surface—to which radiation is to be applied—of the object.

24. The apparatus as claimed in claim 15, wherein the apparatus comprises scanning means that permit the object to be scanned with reference to the apparatus, or permit the apparatus to be scanned with reference to the object.

25. The apparatus as claimed in claim 15, wherein the apparatus comprises scanning means that permit the array of lens elements to be scanned with reference to the object and/or to the array of influencing elements.

26. The apparatus as claimed in claim 25, wherein, in a plane (X, Y) perpendicular to the propagation direction (Z), the array of lens elements is tilted slightly to a scanning direction (X) in which it can be displaced, this scanning direction (X) lying in a plane (X, Y) perpendicular to the propagation direction (Z).

27. An apparatus for applying laser radiation to an object, comprising:
a laser light source for generating laser radiation;
a two-dimensional array of influencing elements that can deflect and/or pass the laser radiation issuing from the laser light source in such a way that laser radiation is applied to prescribable locations on the object; and
a two-dimensional array of lens elements that can focus the laser radiation or portions of the laser radiation onto the surface—to which radiation is to be applied—of the object;
wherein the array of influencing elements can be controlled in such a way that partial beams of the laser radiation impinge in a fashion offset from one another in time on the prescribable locations—to which radiation is to be applied—of the object, or on locations directly adjacent thereto.

28. The apparatus as claimed in claim 27, wherein the desired laser power can be introduced into a prescribable area on the surface—to which radiation is to be applied—of the object by spatial and/or temporal summation.

29. The apparatus as claimed in claim 27, wherein the apparatus comprises two mirror arrays with mirror elements that are arranged in such a way that it is possible to generate partial beams of the laser radiation that impinge asymmetrically in relation to the normal to the surface—to which radiation is to be applied—of the object.

30. The apparatus as claimed in claim 27, wherein the apparatus comprises scanning means that permit the object to be scanned with reference to the apparatus, or permit the apparatus to be scanned with reference to the object.

31. The apparatus as claimed in claim 27, wherein the apparatus comprises scanning means that permit the array of lens elements to be scanned with reference to the object and/or to the array of influencing elements.

32. The apparatus as claimed in claim 31, wherein, in a plane (X, Y) perpendicular to the propagation direction (Z), the array of lens elements is tilted slightly to a scanning direction (X) in which it can be displaced, this scanning direction (X) lying in a plane (X, Y) perpendicular to the propagation direction (Z).

33. A processing apparatus for processing an object, comprising an apparatus as claimed in claim 1.

34. A processing apparatus for processing an object, comprising an apparatus as claimed in claim 15.

35. A processing apparatus for processing an object, comprising an apparatus as claimed in claim 27.

36. A printing apparatus for printing image information, comprising an apparatus as claimed in claim 1.

37. A printing apparatus for printing image information, comprising an apparatus as claimed in claim 15.

38. A printing apparatus for printing image information, comprising an apparatus as claimed in claim 27.
